(19) United States
(12) Patent Application Publication
(10) Pub. No.: US 2010/0252020 A1
(43) Pub. Date: Oct. 7, 2010

(54) TWO RING GRILL BURNER AND CONTROL VALVE

(76) Inventor: Alex Siow, Berkeley, CA (US)

Correspondence Address: DERGOSITS & NOAH LLP, Three Embarcadero Center, Suite 410, SAN FRANCISCO, CA, 94111, US

(21) Appl. No.: 12/732,563

(22) Filed: Mar. 26, 2010

Related U.S. Application Data
(60) Provisional application No. 61/165,866, filed on Apr. 1, 2009.

(51) Int. Cl. A47J 37/07; F24C 3/08; F23H 13/00

(52) U.S. Cl. 126/25 R; 126/39 E; 126/152 R

(57) ABSTRACT

A grill includes a grate for supporting food, an inner burner and an outer burner that are both mounted under the grate. A control valve is coupled to the inner and outer burners. The control valve has a first mode of operation which controls the heat produced by the outer burner only and prevents the inner burner from emitting heat. Food placed in the middle of the grate is exposed to indirect convection heating. The control valve also has a second mode of operation which controls the heat produced by both the inner and outer burners.

### CROSS REFERENCE TO RELATED APPLICATION

This application claims priority to U.S. Provisional Patent Application No. 61/165,866, TWO RING GRILL BURNER, filed Apr. 1, 2009, the contents of which are incorporated by reference it its entirety.

### FIELD OF INVENTION

The present invention is directed towards a grill for cooking food.

### BACKGROUND

Barbecues are used for cooking food, often meat, with the heat and hot gases. Gas barbecue grills use a flammable gas such as propane to fuel a flame used to cook the food. A typical gas grill includes a fuel storage container, a pressure regulator, a control valve, a burner and a cooking grate. The flammable gas is typically stored in a storage cylinder. A valve at the top of the cylinder is open to allow the cylinder to be filled and also allow the flammable gas to flow from the cylinder to the grill. A pressure regulator is coupled to the valve to reduce the pressure of the flammable gas flowing to the grill.

The flammable gas flows through a tube to a gas flow control valve that controls the flow rate of the gas to a burner. A cooking grate is mounted over the burner to support the food that is being cooked. In order to light the burner, the control valve is opened so that the gas flows to the burner. A flame or spark is then provided to ignite the gas. The burner directs the flames towards the cooking grate so the food is exposed to the heat and flames. The grill can also include a housing that surrounds the bottom portion of the grip and a lid covers a volume of space over the cooking grate. The lid can be opened for access to the cooking grating and allow the user to place, move or remove food from the grate. The lid can also be closed to trap the heat around the food and allow for convection heat transfer to the food.

### SUMMARY OF THE INVENTION

The invention is directed towards a grill having two burners that are concentrically configured that are both coupled to a single control valve. The valve has two modes of operation. In the one mode of operation the control valve controls the heat emitted by only the outer burner. Food is placed in the center of the grate and the lid is closed which results in indirect heating and convection cooking of the food. In the second mode, the control valve controls the heat emitted by both the inner and outer burner for direct heating of the food. The lid can also be placed over the food so the food is cooked by both direct and indirect heat. The heating can be from the burning of a flammable gas such as propane or natural gas.

### BRIEF DESCRIPTION OF THE DRAWINGS

FIG. 1 is a view of a two burner grill;

FIG. 2 is a view of a control knob in a direct heat mode;

FIG. 3 is a view of a control knob in an indirect heat mode;

FIG. 4 is a view of a two burner grill having a rectangular shape;

FIG. 5 is a view of a grill having a rectangular shape and two sets of burners;

FIG. 6 is a view of the control knob in the off position;

FIG. 7 is a view of the control knob in the start position;

FIG. 8 is a view of the control knob in the dual burner control region;

FIG. 9 is a view of the control knob in the indirect single burner control region;

FIG. 10 is a side view of an embodiment of the grill;

FIG. 11 is a cross section top view of the grill with a table extended;

FIG. 12 is a side view of an embodiment of the grill with a table extended;

FIG. 13 is a side cross section view of the burner with the outer burner indirectly heating the food; and

FIG. 14 is a side cross section view of the burner with the outer burner directly heating the food.

### DETAILED DESCRIPTION

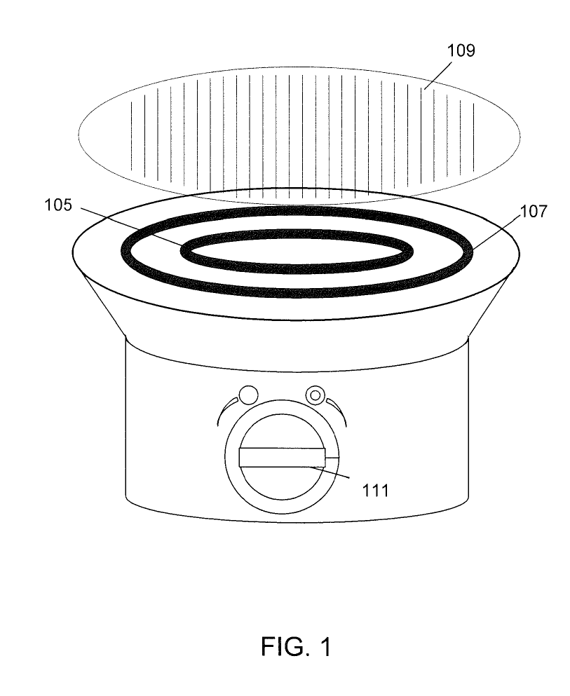

With reference to FIG. 1, the present invention is directed towards a cooking grill 100 that includes an inner burner 105 and an outer burner 107 mounted under a grate 109 that food is placed on. The grate 109 defines the cooking area. The outer burner 107 can be mounted under an outer portion of the grate 109 and the inner burner 105 can be mounted under the inner center portion of the grate 109. A control knob 111 that operates a control valve (not shown). The control valve is coupled between a gas source and controls the flow of gas to the inner burner 105 and the outer burner 107. The inner burner 105 and the outer burner 107 have a hollow tubular structure that has a plurality of small holes which extend along the entire length of the burner and allows the gas to escape on its sides. As the flammable gas exits the burners 105, 107, the gas is mixed with the ambient oxygen and burned which produces heat to cook the food on the grate 109. The gas flow rate to the burners 105, 107 is proportional to the heat produced by the burners 105, 107. In an embodiment, at the maximum gas flow rates, the inner burner 105 may produce up to about 15,000 btu/hour and the outer burner 107 may produce up to about 24,000 btu/hour. In other embodiments, the burners 105, 107 can produce higher heat outputs.

The shapes of the burners 105, 107 can correspond to the shape of the grate 109. For example as illustrated in FIG. 1, if the grate 109 is circular, the inner burner 105 and the outer burner 107 can also be circular in shape. The outer burner 107 can be close to an outer perimeter of the grate 109. The outer burner 107 may be mounted under the outer 50% of the grate 109 and the inner burner 105 can be mounted under the inner 50% of the grate 109. To evenly distribute the heat, the burners may be evenly spaced under the grate 109. The outer burner 107 may be at about 60 to 90% of the outer diameter and the inner burner 105 may be at 20 to 40% of the outer diameter.

The gas grill burners are typically constructed of: stainless steel, aluminized steel, cast iron that may be porcelain-coated, or any other suitable material. The burners are hollow with gas inlet holes and outlet ‘ports’. The cooking grates are typically made of: Stainless steel, Porcelain-coated cast iron, Porcelain-coated steel, Cast Iron, Chrome-plated steel or any other suitable material. To reduce the occurrence of flare up, many barbecues employ methods to prevent oil or fat dropping onto the heat source by fitting the plates, baffles, a drip cup or other products to intercept the dripping flameable fluids such as meat juices.

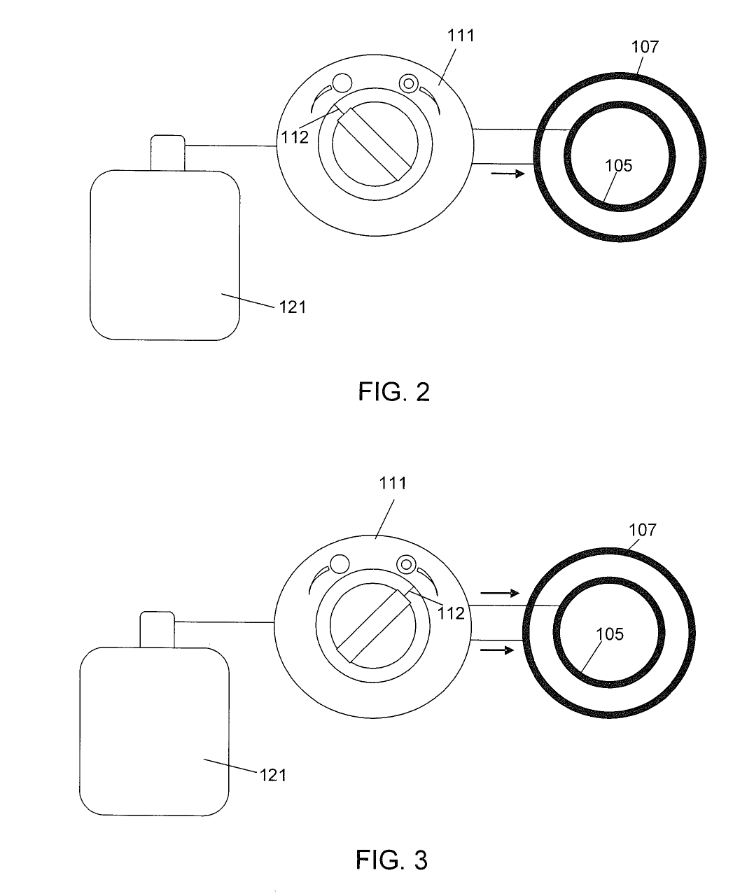

With reference to FIGS. 2 and 3, the gas can be propane which can be stored in tank 121 or alternatively, the gas can be natural gas obtained directly from a natural gas supply pipe. The gas flows to the control valve that provides two modes of operation for the grill. In a first mode shown in FIG. 2, the control knob 111 set to the first mode of operation. In this embodiment the first mode of operation is designated by the indicator 112 positioned to the right of center and the valve only provides gas to the outer burner 107 and prevents gas from flowing to the inner burner 105. The control knob 111 is set to the second mode of operation which in this embodiment is left of center. In the second mode shown in FIG. 3, the valve controls the flow of gas simultaneously to both the inner burner 105 and the outer burner 107.

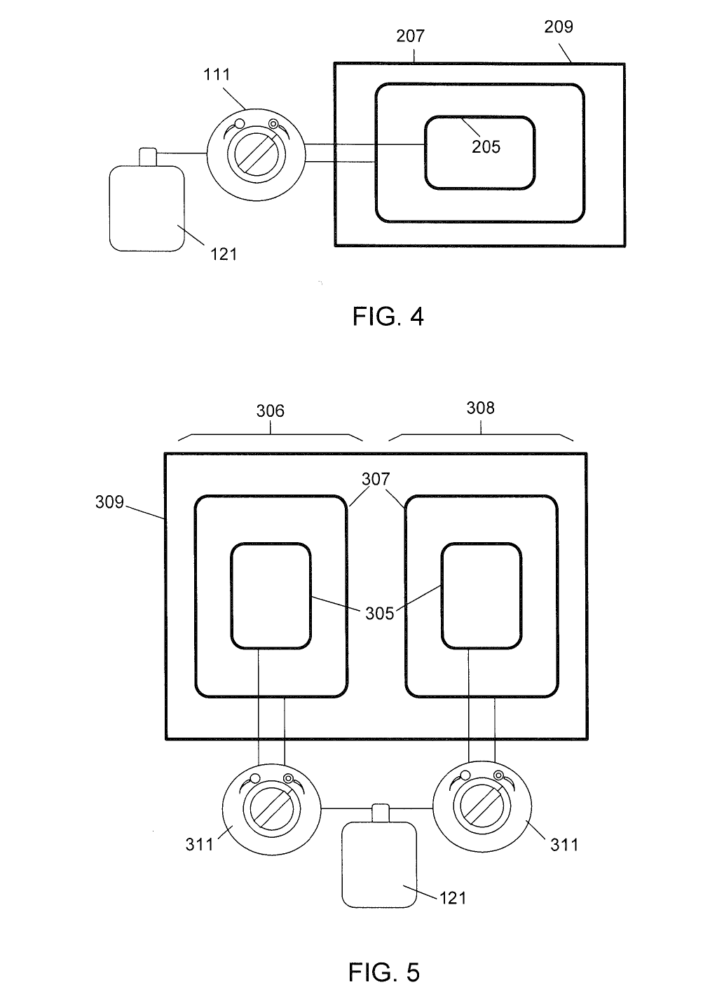

While the grates illustrated in FIGS. 1-3 are circular, in other embodiments the grate can be various other shapes. For example, with reference to FIG. 4, the grate 209 can be rectangular.

For clarity, only the outer edges of the grate 209 are illustrated. The burners 205, 207 can also be generally rectangular in shape with the outer burner 207 can be mounted under an outer portion of the grate 209 and the inner burner 205 can be mounted under an inner portion of the grate 209. The inner burner 205 and the outer burner 207 are coupled to the single control valve 111 and a flammable gas source 121.

In other embodiments, the grill may have multiple sets of inner and outer burners that are distributed under separate areas of the grate. With reference to FIG. 5, a rectangular grate 309 is illustrated that has a first set of burners 306 under the left side of the grate 309 and a second set of burners 308 under the right side. Each set of burners includes an inner burner 305 and an outer burner 307 and each set of burners can be controlled by a separate control valve 311 that allow each set of burners 306, 308 to be operated independently. The control valves 311 can be coupled to the same gas source 121 or separate gas sources.

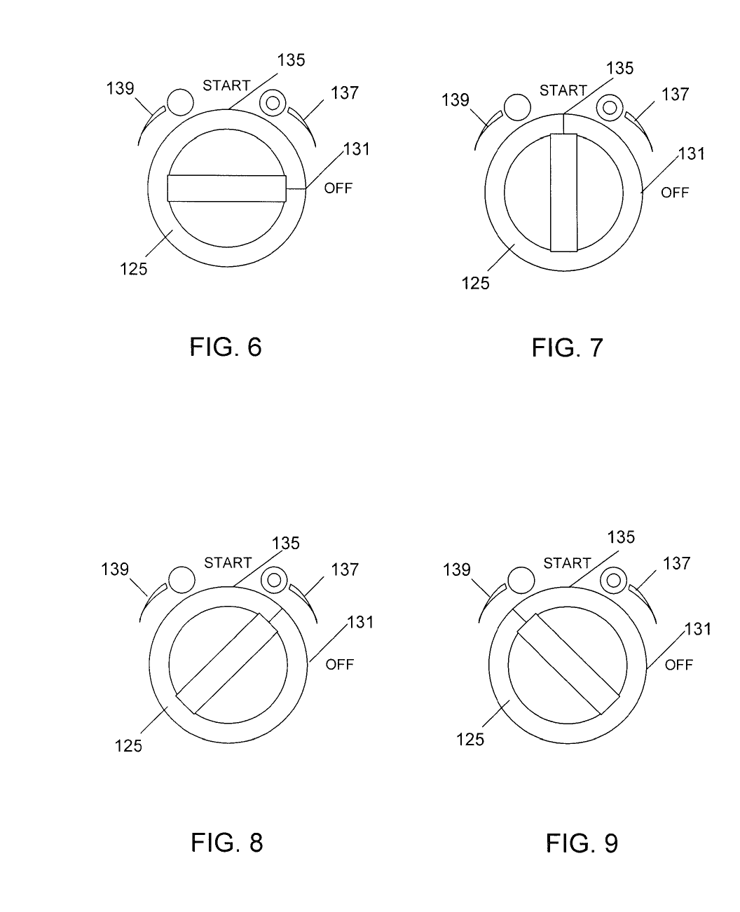

With reference to FIGS. 6-9, in an embodiment the control valve is coupled to a single rotatable control knob 125. The control knob 125 can have multiple rotation regions and positions. With reference to FIG. 6, the control knob 125 is illustrated in the off position 131. Gas cannot flow to either the inner burner or the outer burner. With reference to FIG. 7, the control knob 125 is in the start position 135. Gas flows to the burners and an ignition spark unit is used to light the burners. In an embodiment, the spark used to ignite the burners can be provided by an electrical voltage applied between electrical conductors. The voltage can cause a spark to be transmitted between the electrical conductors. The spark ignites the gas emitted from one area of the burners and the flame then spreads across the entire burner. With reference to FIG. 8, the control knob 125 is in the dual burner region 137 which provides direct heat to the grate. The gas flow can be controlled by rotating the control knob 125 clockwise within the dual burner region 137 to reduce the flow of gas and heat. The control knob 125 is counter clockwise to increase the flow of gas and heat. With reference to FIG. 9, the control knob 125 is in the outer burner region 139 which provides indirect heat to food placed in the center of the grate. The gas flow can be controlled by rotating the control knob 125 clockwise within the outer burner region 139 to increase the flow of gas and heat and counter clockwise to reduce the flow of gas and heat.

In other embodiments, the control knob can be configured to operate in a different manner. For example, a center position may be the off position and rotation away from the center position can increase the gas flow rate. Rotation in clockwise direction from the center off position can cause just the outer burner to function and rotation in the clock clockwise direction can cause both the inner and outer burners to function. Various other combinations of valve control operations are contemplated.

The control valve can include one or more variable orifices that control the flow rate of the gas to the burners. The orifice produces flow resistance which reduces the flow rate. To slow the flow of gas, the orifice size is reduced to increase the flow resistance and to increase the flow of gas, the orifice size is increased.

The valve and control knob 125 can also have safety features that prevent the user from accidentally turning on the flow of gas. For example, the knob 125 may need to be pressed in before it can be rotated away from the off position 131. This requirement will prevent the burners from accidentally being turned on. The system may also require the knob 125 to be pressed in before the burners are lit in the start position 135. The knob 125 may also have to be pressed in when switching between the dual burner region 137 and the outer burner region 139. This prevents the operator from accidently switching the cooking mode.

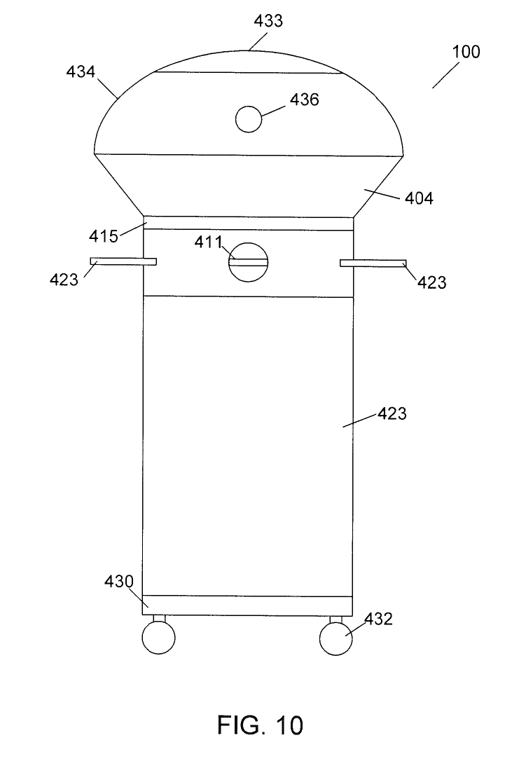

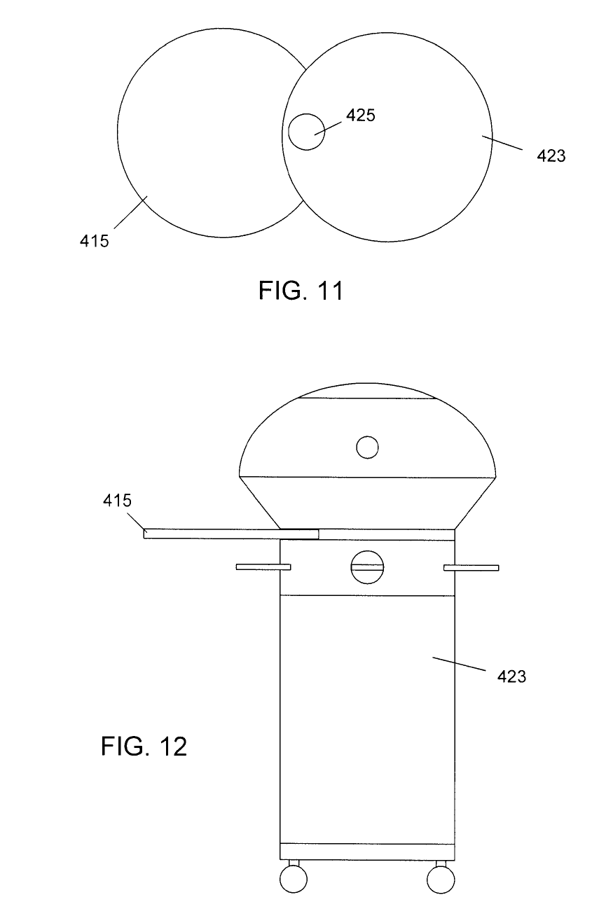

With reference to FIG. 10, an embodiment of the assembled grill 100 is illustrated. The grill 100 can include a lid 434, a lid handle 433, a temperature gage 436, a fire bowl 404, a control knob 411, a frame 423, handles 420, a base 430 and wheels 432. The flammable fluid tank can be stored in the frame 423 and the burners are mounted in the fire bowl 404. The frame 423 can be cylindrical in shape, the fire bowl 404 can be an inverted partial cone and the lid 434 can be a generally hemispherical shape. With reference to FIGS. 10, 11 and 12, in an embodiment, the grill 100 can also include a swing out table 415. In FIG. 10, the table 415 is retracted within the grill 100 above the frame 423. In FIG. 11 is a cross section top view of the table 415 extended out from the frame 423 and FIG. 12 is a side view of the table 415 extended out from the frame 423. The table 415 may have a pivot point 425 that allows the table 415 to rotate between the retracted and extended positions. In other embodiments, the table 415 may slide in and out of the grill.

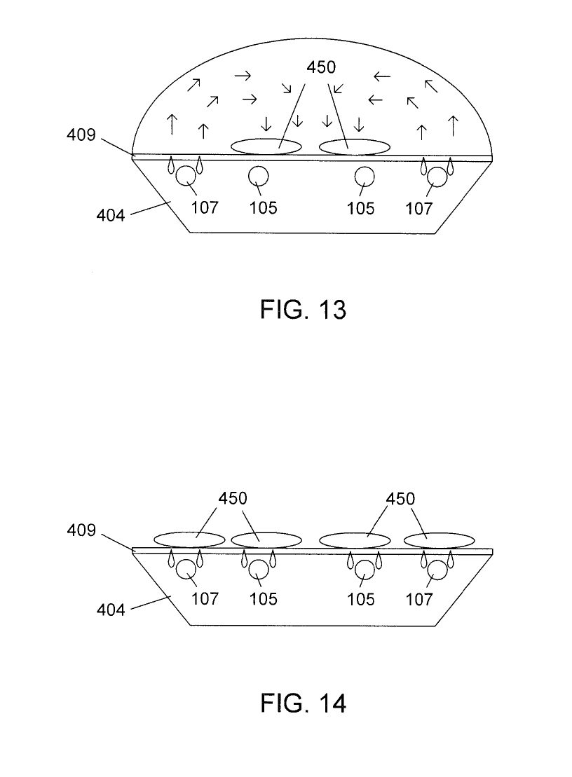

With reference to FIG. 13, a cross sectional side view of the grill 101 is illustrated. When cooking with only the outer burner 107 on, the lid 434 can be placed over the fire bowl 404. The flames from the outer burner 407 produce heat which rises and is directed by the lid 434 back to the center of the grate 409 to the food items 450. Since the inner burner 105 is off, the food is not cooked by this burner. This indirect heating is commonly known as convection cooking.

With reference to FIG. 14, a cross sectional side view of the grill 101 is illustrated. When cooking with both the inner burner 105 and the outer burner 107 on, the lid can be removed or placed over the fire bowl 404. The flames from the inner burner 105 and the outer burner 407 produce heat which rises directly cooks the food items 450. If the lid is placed over the fire bowl 404, the internal gas heat will also cook the food by convection heating.

The described burner control is substantially different than traditional gas grills. In a traditional gas grill, multiple burners which are each placed under different portions of the grate. Each burner has a different control valve and control knob. In order to cook with indirect heat, the food must be placed over one area of the grate and only burners that are under a different portion of the grate are ignited. Because most grills have a rectangular cooking surface, the food is placed on one side of the grate and the burners on the opposite side produce the cooking heat. Because the heat is not uniformly distributed across the grate, the food on different areas of the grill will be exposed to different temperatures and cook at the different rates.

It will be understood that the inventive system has been described with reference to particular embodiments, however additions, deletions and changes could be made to these embodiments without departing from the scope of the inventive system. Although the invention has been described to include various components, it is well understood that these components and the described configuration can be modified and rearranged in various other configurations. Any discussion of physical dimension is exemplary only, and is not intended to limit the present invention in any way.

What is claimed is:

1. A gas grill comprising:
a grate;
an outer burner under an outer portion of the grate;
an inner burner under an inner portion of the grate;
a flammable gas supply;
a frame that supports the grate, the outer burner, the inner burner and the lid;
a control valve coupled to the outer burner, the inner burner and the flammable gas supply, the control valve having: 1) a first mode of operation that controls the flow rate of the flammable gas to the outer annular burner and blocks the flow of the flammable gas to the inner burner, 2) a second mode of operation that controls the flow of the flammable gas to both the inner burner and the outer burner simultaneously, and 3) an off position.

2. The gas grill of claim 1 wherein the grate is substantially circular in shape and the outer burner is substantially circular in shape.

3. The gas grill of claim 2 wherein the inner burner is substantially circular in shape and positioned concentric to the outer burner.

4. The gas grill of claim 1 wherein the outer portion of the grate is more than 50% of the radius measured from the center of the grate and the inner portion is less than 50% of the radius measured from the center of the grate.

5. The gas grill of claim 1 wherein the outer portion of the grate is more than 60% of the radius measured from the center of the grate and the inner portion is less than 40% of the radius measured from the center of the grate.

6. The gas grill of claim 1 further comprising a rotatable control knob coupled to the control valve and mounted on a surface of the gas grill that is rotated to change the control valve between the first mode of operation and the second mode of operation.

7. The gas grill of claim 6 wherein the control valve controls the flow rate of the gas to the inner burner and the outer burner.

8. The gas grill of claim 6 wherein the control valve blocks the flow of the flammable gas to the inner and outer burner when the control knob is in an off position.

9. The gas grill of claim 8 wherein the control valve is in the first mode of operation when the control knob is rotated in a first direction from the off position and the control valve is in the second mode of operation when the control knob is rotated in a second direction from the off position that is opposite of the first direction.

10. The gas grill of claim 1 further comprising:
a frame that supports the grate, the outer burner and the inner burner; and
a lid that covers the grate.

11. A gas grill comprising:
a grate;
an outer burner under an outer portion of the grate;
an inner burner under an inner portion of the grate;
a flammable gas supply; and
a control valve coupled to the outer burner and the inner burner, the control valve having a first mode of operation that controls the heat emitted by the outer annular burner and prevents the inner burner from emitting heat and a second mode of operation that controls the heat emitted by both the inner burner and the outer burner simultaneously.

12. The gas grill of claim 11 wherein the grate is substantially circular in shape and the outer burner is substantially circular in shape.

13. The gas grill of claim 12 wherein the inner burner is substantially circular in shape and positioned concentric to the outer burner.

14. The gas grill of claim 11 wherein the outer portion of the grate is more than 50% of the radius measured from the center of the grate and the inner portion is less than 50% of the radius measured from the center of the grate.

15. The gas grill of claim 11 wherein the outer portion of the grate is more than 60% of the radius measured from the center of the grate and the inner portion is less than 40% of the radius measured from the center of the grate.

16. The gas grill of claim 11 further comprising a rotatable control knob coupled to the control valve and mounted on a surface of the gas grill that is rotated to change the control valve between the first mode of operation and the second mode of operation.

17. The gas grill of claim 16 wherein the control valve controls the flow rate of the gas to the inner burner and the outer burner.

18. The gas grill of claim 16 wherein the control valve blocks the flow of the flammable gas to the inner and outer burner when the control knob is in an off position.

19. The gas grill of claim 18 wherein the control valve is in the first mode of operation when the control knob is rotated in a first direction from the off position and the control valve is in the second mode of operation when the control knob is rotated in a second direction from the off position that is opposite of the first direction.

20. The gas grill of claim 11 further comprising:
a frame that supports the grate, the outer burner and the inner burner; and
a lid that covers the grate.
